(19) United States
(12) Patent Application Publication
(10) Pub. No.: US 2015/0003051 A1
(43) Pub. Date: Jan. 1, 2015

(54) SELF-ILLUMINATING POST TRAY ASSEMBLY

(71) Applicant: Barry Lewis, Bethlehem, PA (US)

(72) Inventor: Barry Lewis, Bethlehem, PA (US)

(21) Appl. No.: 14/321,197

(22) Filed: Jul. 1, 2014

Related U.S. Application Data
(60) Provisional application No. 61/841,437, filed on Jul. 1, 2013.

(51) Int. Cl. F21S 9/03

(52) U.S. Cl. CPC F21S 9/035
USPC 362/183

(57) ABSTRACT

A tray assembly is disclosed. The tray assembly includes a generally planar substrate having a top surface and a bottom surface, a sleeve extending downwardly from the bottom surface of the substrate, and a solar cell integrated into the top surface. A light source is electrically coupled to the solar cell.

### CROSS-REFERENCE TO RELATED APPLICATION

The present application claims priority from U.S. Provisional Patent Application Ser. No. 61/841,437, filed on Jul. 1, 2013, which is incorporated by reference herein in its entirety.

### BACKGROUND OF THE INVENTION

Solar powered lighting is often used to generate light without the necessity of requiring electrical cables and outlets or replacing worn out batteries. Additionally, it is often desirable to provide low intensity light for ambiance at evening parties. These parties often require trays that are used to support food and drinks that are being consumed at such parties.

It would be beneficial to provide a product that combines the benefits of solar powered low intensity lighting with trays for use at evening parties.

### BRIEF SUMMARY OF THE INVENTION

Briefly, the present invention provides a tray assembly. The tray assembly includes a generally planar substrate having a top surface and a bottom surface, a sleeve extending downwardly from the bottom surface of the substrate, and a solar cell integrated into the top surface. A light source is electrically coupled to the solar cell.

Additionally, the present invention is a tray assembly kit comprising a tray assembly having a generally planar substrate having a top surface and a bottom surface, a solar cell integrated into the top surface, and a light source electrically coupled to the solar cell. A first sleeve has a generally round inner perimeter. A second sleeve has a generally square inner perimeter. Fastening means releasably secures one of the first sleeve and the second sleeve to the bottom surface of the substrate.

Further, the present invention provides a tray assembly comprising a generally planar substrate having a top surface, a bottom surface, and a perimeter defining the substrate. A rim extends upwardly from the top surface along the perimeter. A solar cell is integrated into the top surface. A first light is integrated into the top surface and a second light is integrated into the rim. The first and second lights are electrically coupled to the solar cell. A battery is electrically coupled to the solar cell to receive electrical energy from the solar cell and to the first light and the second light to transmit electrical energy to the first light and the second light.

### BRIEF DESCRIPTION OF THE DRAWINGS

The accompanying drawings, which are incorporated herein and constitute part of this specification, illustrate the presently preferred embodiments of the invention, and, together with the general description given above and the detailed description given below, serve to explain the features of the invention. In the drawings:

FIG. 1 is a perspective view of a tray assembly according to a first exemplary embodiment of the present invention, with the tray assembly being in a de-activated condition;

FIG. 2 is a perspective view of the tray assembly shown in FIG. 1, with the tray assembly being in an activated condition;

FIG. 3 is an electrical schematic drawing showing an exemplary electrical circuit for operating the tray assembly shown in FIG. 1;

FIG. 4 is a bottom plan view of the tray assembly shown in FIG. 1; and

FIG. 5 is a bottom plan view of a tray assembly according to a second exemplary embodiment of the present invention; and

FIG. 6 is a perspective view of the tray assembly shown in FIG. 2, with a glass and a bottle placed on the tray assembly.

### DETAILED DESCRIPTION OF THE INVENTION

In the drawings, like numerals indicate like elements throughout. Certain terminology is used herein for convenience only and is not to be taken as a limitation on the present invention. The terminology includes the words specifically mentioned, derivatives thereof and words of similar import. The embodiments illustrated below are not intended to be exhaustive or to limit the invention to the precise form disclosed. These embodiments are chosen and described to best explain the principle of the invention and its application and practical use and to enable others skilled in the art to best utilize the invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

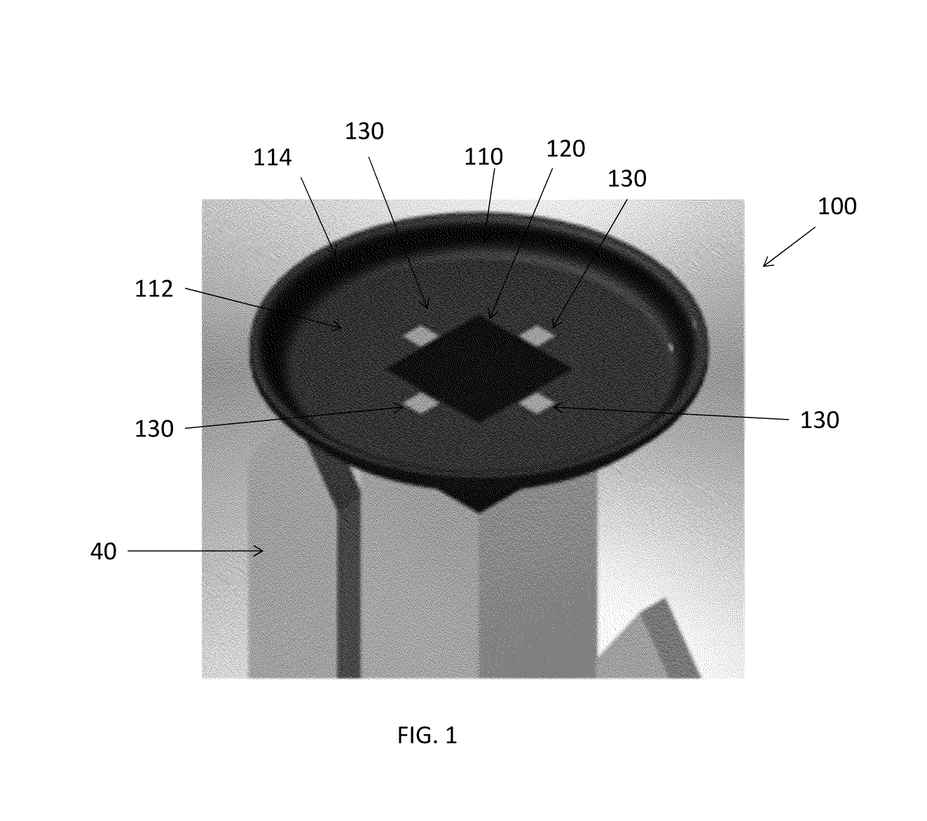

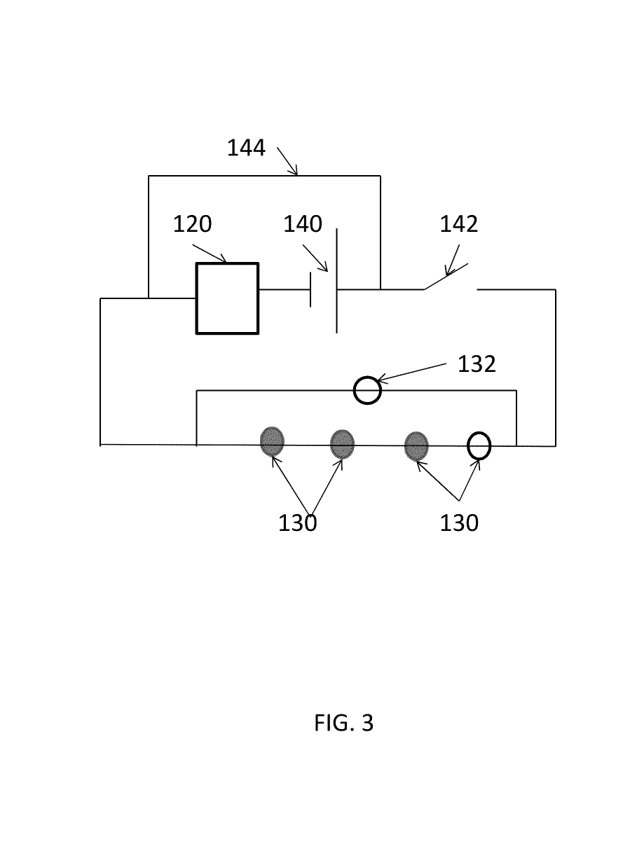

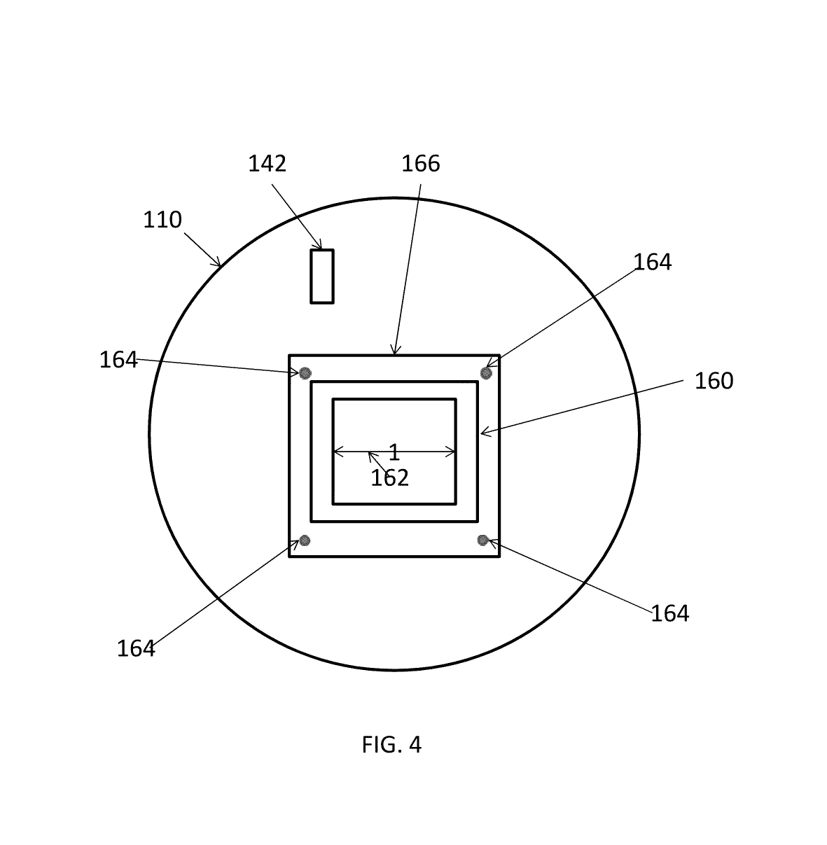

Referring to FIGS. 1-4 and 6, a self-illuminating tray assembly 100 according to a first exemplary embodiment of the present invention is shown. Tray assembly 100 may be removably attached to a fencepost 40 or other vertical structure and provides self-illumination to illuminate articles, such as a bottle 50 and/or a glass 52, shown in FIG. 3, that may be placed on tray assembly 100.

Tray assembly 100 includes a tray 110 having generally planar substrate 112 surrounded by a rim 114 extending upwardly from a top surface of substrate 112. While a generally round substrate 112 is shown, those skilled in the art will recognize that substrate 112 may be other shapes, such as square, rectangular, or other suitable shape.

A solar cell 120 is located generally in the center of substrate 112 and is embedded in substrate 112. Although a generally square solar cell 120 is shown, those skilled in the art will recognize that solar cell 120 may be other shapes, that solar cell 120 may be located in different locations on substrate 112, and that more than one solar cell 120 may be used.

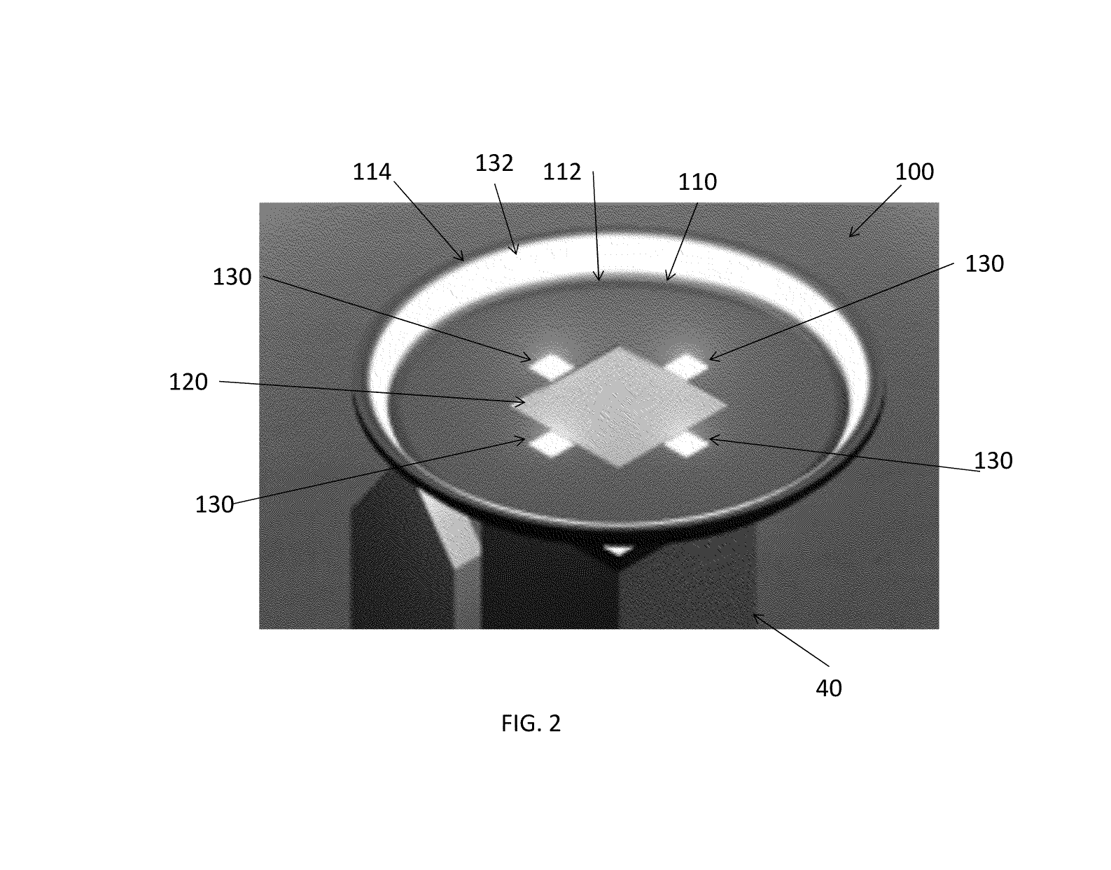

A plurality of light sources 130 are embedded in substrate 112 and generate a light that shines upwardly from substrate 130. Light sources 130 may be LED's or other suitable light sources configured to emit white light, colored light, or a sequence of rotating colors. While four (4) light sources 130 are shown in FIGS. 1 and 2, with each light source 130 extending from a side of solar cell 120, those skilled in the art will recognize that more or less than four light sources 130 may be used, and that light sources 130 may be located at different locations around substrate 112.

Rim 114 includes a light source 132 that extends around an inner portion thereof to illuminate toward the interior of tray 110. Similarly to light sources 130, light source 132 may also be an LED or other suitable light source configured to emit white light, colored light, or a sequence of rotating colors.

Light sources 130 and light source 132 may be electrically connected to solar cell 120 such that solar cell 120 absorbs sunlight during daylight and generates electrical power to operate light sources 130, 132, such as, for example, at night. An exemplary schematic of an electrical circuit used to power light sources 130, 132 is shown in FIG. 3.

FIG. 3 shows a supplemental power source, such as battery 140, that is charged by solar cell 120. A switch 142, such as a photovoltaic switch that will close at a predetermined light intensity level, may be operated to close the electrical circuit and provide electrical power to light sources 130, 132. Switch 142 is shown on the bottom surface of substrate 112. Although not shown in FIGS. 1 and 2, battery 140 may be embedded in substrate 112. Optionally, switch 142 may be a manually operated switch and can be located on the bottom of substrate 112 or along rim 114.

A closed circuit 144 enables solar cell 120 to charge battery 140. When switch 142 is open, all power generated by solar cell 120 is stored in battery 140. When switch 142 is closed, power stored in battery 140, as well as any power generated by solar cell 120, is used to power light sources 130, 132. Optionally, switch 142 may be omitted.

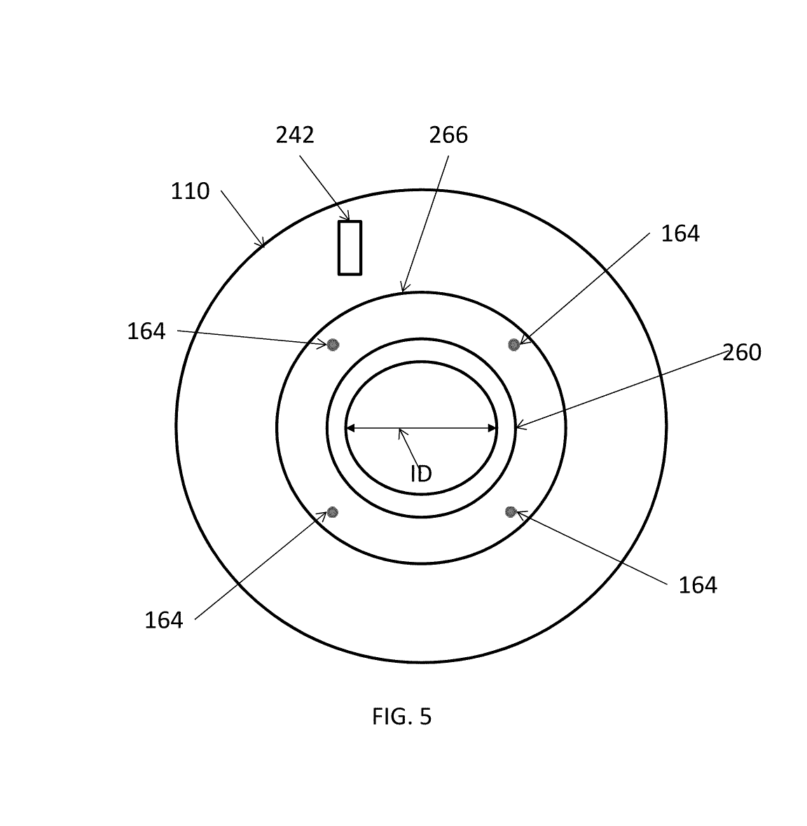

A bottom view of tray assembly 100 is shown in FIG. 5. Tray assembly 100 includes a sleeve 160 that extends downwardly from a bottom surface of tray 110. In an exemplary embodiment, sleeve 160 may extend between about 2 inches and about 4 inches from the bottom of tray 110. As shown in FIG. 5, an inner perimeter of sleeve 160 is generally square in shape and is sized such that an inner side 162 of sleeve 160 is only slightly larger than a side of post 40 so that sleeve 160 can slip over the top of post 40, with tray 110 resting on the top of post 40. The slight excessive size of inner side 160 over the size of the side of post 40 prevents tray assembly 100 from excessively wobbling on the top of post 40.

Optionally, sleeve 160 may be releasably secured to the bottom of tray 110, such as, for example, by screws 164. While four (4) screws 164 are shown, those skilled in the art will recognize that more or less than four screws 164 can be used to secure sleeve 160 to the bottom of tray 110. Screws 164 are screwed through a sleeve lip 166 that extends outwardly from sleeve 160.

As shown in an alternative embodiment shown in FIG. 5, instead of a square sleeve 160, a sleeve 260 having a generally round inner perimeter may extend from the bottom of tray 110. Similar to sleeve 160, sleeve 260 may extend between about 2 inches and about 4inches from the bottom of tray 110. Also, sleeve 260 may be releasably secured to the bottom of tray 110.

Sleeve 260 may be used to set tray 110 on top of a round fencepost (not shown), such as the type used with cyclone fencing. The inner diameter ID of sleeve 260 is slightly larger than the outer diameter of the round fence post so that sleeve 260 can slip over the top of the round post, with tray 110 resting on the top of the post. The slight excessive size of inner diameter ID over the size of the side of the post prevents tray assembly 100 from excessively wobbling on the top of the post. Screws 164 are screwed through a sleeve lip 266 that extends outwardly from sleeve 260.

Optionally, tray assembly 100 may be a kit that includes tray 110, sleeve 160, sleeve 260, as well as screws 162 to enable a user to selectively attach either sleeve 160 or sleeve 260 to the bottom of tray 110 to fit onto a square fence post 40 or a round fence post, as desired by the user. Hole patterns for screws 164 in bottom of tray 110, sleeve lip 166, and sleeve lip 266 are arranged so that sleeve 160 and sleeve 260 are interchangeably connectable to tray 110. A further, optional embodiment of the kit includes a plurality of sleeves 160 and sleeves 260, each sized with differing internal dimensions to accommodate fence posts 40 of differing outer dimensions.

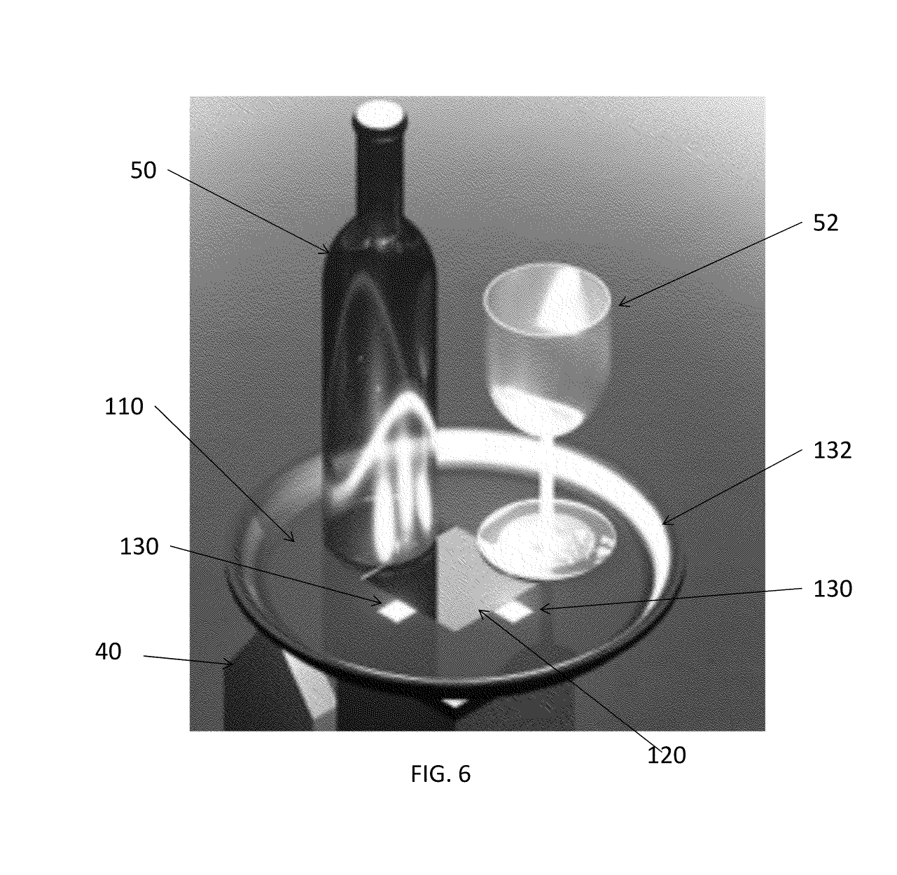

As shown in FIG. 6, bottle 50, a glass 52, or both may be placed on tray 110 over a light source 130 such that light source 130 shines into and through bottle 50 and glass 52, illuminating bottle 50 and glass 52, as well as the contents thereof. Additionally, light source 132 illuminates bottle 50 and glass 52 from the sides, enhancing the lighting effect.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A tray assembly comprising:
a generally planar substrate having a top surface and a bottom surface;
a sleeve extending downwardly from the bottom surface of the substrate;
a solar cell integrated into the top surface; and
a light source electrically coupled to the solar cell.

2. The tray assembly according to claim 1, further comprising:
a rim extending upwardly from the top surface around a perimeter of the substrate; and
the light source being integrated into the rim.

3. The tray assembly according to claim 1, wherein the light source is integrated into the top surface.

4. The tray assembly according to claim 1, further comprising a supplemental power source electrically coupled to the light source.

5. The tray assembly according to claim 4, wherein the supplemental power source is electrically coupled to the solar cell.

6. The tray assembly according to claim 5, further comprising an electrical switch operable between a closed position wherein the light source is powered by one of the solar cell and the supplemental power source and an open position wherein the solar cell provides electrical power to the supplemental power source.

7. The tray assembly according to claim 6, wherein the electrical switch comprises a photovoltaic switch.

8. The tray assembly according to claim 1, wherein the sleeve is removably coupled to the substrate.

9. The tray assembly according to claim 1, wherein the sleeve is sized to fit over a fence post.

10. The tray assembly according to claim 1, wherein the solar cell in located in a center portion of the top surface.

11. The tray assembly according to claim 10, wherein the light source comprises a plurality of light sources spaced around the solar cell.

12. A tray assembly kit comprising:
a tray assembly comprising:
a generally planar substrate having a top surface and a bottom surface;
a solar cell integrated into the top surface; and
a light source electrically coupled to the solar cell; and
a first sleeve;
a second sleeve; and
fastening means to releasably secure one of the first sleeve and the second sleeve to the bottom surface of the substrate.

13. The kit according to claim 12, wherein the first sleeve has a generally round inner perimeter and the second sleeve has a generally square inner perimeter.

14. The kit according to claim 12, wherein the first sleeve has a first inner diameter and the second sleeve has a second inner diameter, different than the first inner diameter.

15. A tray assembly comprising:
a generally planar substrate having a top surface, a bottom surface, and a perimeter defining the substrate;
a rim extending upwardly from the top surface along the perimeter;
a solar cell integrated into the top surface;
a first light integrated into the top surface, the first light being electrically coupled to the solar cell;
a second light integrated into the rim, the second light being electrically coupled to the solar cell; and
a battery electrically coupled to the solar cell to receive electrical energy from the solar cell, and to the first light and the second light to transmit electrical energy to the first light and the second light.

16. The tray assembly according to claim 16, further comprising a sleeve extending downwardly from the bottom surface of the substrate.

17. The tray assembly according to claim 16, wherein the sleeve has a generally square inner perimeter.

18. The tray assembly according to claim 16, wherein the sleeve has a generally circular inner perimeter.

19. The tray assembly according to claim 15, further comprising a switch operatively coupled to the battery such that, when the switch is in an open position, the solar cell electrically charges the battery and wherein, when the switch is in a closed position, the battery powers the first light and the second light.

20. The tray assembly according to claim 15, wherein the first light comprises a plurality of lights disposed around the solar cell.
